(19) United States
(12) Patent Application Publication
(10) Pub. No.: US 2011/0159234 A1
(43) Pub. Date: Jun. 30, 2011

(54) ORNAMENT ASSEMBLY WITH ADJUSTABLE MOUNTING LOCATIONS

(76) Inventor: Chih-Yuan PAI, Taichung County (TW)

(21) Appl. No.: 12/975,953

(22) Filed: Dec. 22, 2010

(30) Foreign Application Priority Data
Dec. 24, 2009 (TW) 098224220

(51) Int. Cl. B32B 3/06; B32B 3/10

(52) U.S. Cl. 428/100; 428/195.1

(57) ABSTRACT

An ornament with adjustable mounting locations includes an ornament unit and an adhesion unit. The ornament unit has a baseboard and a pattern layer located on the baseboard. The adhesion unit has a first adhesion member fastened to a rear surface of the baseboard. Thus the size and hung location of the ornament unit can be adjusted as desired.

### FIELD OF THE INVENTION

The present invention relates to a hanging ornament assembly and particularly to an ornament assembly with adjustable mounting locations.

### BACKGROUND OF THE INVENTION

A conventional ornament hung on a wall commonly has a prefixed hook on the back side to hang on a nail fastened to the wall. In the event that the ornament is to be changed for a different location or replaced by another ornament, the location of the nail might need to change, and then a nail pit is left behind on the wall that could become an eyesore.

To solve the aforesaid problem a traceless hanging hook has been developed and marketed. The hook generally includes a baseboard with a adhesive strip located on an inner side to be bonded to a wall. The baseboard further has an outer side with an upper lid latched thereon to hold a hook to hang an ornament. The traceless hanging hook thus formed has a protrusion part and is exposed outside the ornament when in use, thus is not aesthetic appealing. In addition, it would be inconvenient to a user that a hanging rope has to be provided when he wants to hang an ornament.

### SUMMARY OF THE INVENTION

The primary object of the present invention is to provide an ornament assembly with adjustable mounting locations that is simply structured and can be easily hung to suit adjustment of ornament size and hanging location.

In accordance with the present invention, the ornament assembly includes an ornament unit and an adhesion unit. The ornament unit has a baseboard and a pattern layer. The baseboard has a rear side and a front side opposite to the rear side. The pattern layer is located on the front side. The adhesion unit has a first adhesion member fastened to the rear side of the baseboard.

Through the structure set forth above, the adhesion unit can match the ornament unit to adjust the hanging location of the ornament unit, and make change of different types and sizes of the ornament unit easier without damaging the wall and improve aesthetic appeal.

The foregoing, as well as additional objects, features and advantages of the invention will be more readily apparent from the following embodiment and detailed description, which proceeds with reference to the accompanying drawings.

### BRIEF DESCRIPTION OF THE DRAWINGS

FIG. 1 is a perspective exploded view of an embodiment of the ornament assembly of the present invention.

FIG. 2 is a sectional exploded view of the embodiment of the ornament assembly of the present invention.

FIG. 3 is a sectional schematic view of the embodiment of the present invention in an installed condition adjusted up and down.

FIG. 4 is a plane schematic view of the embodiment of the present invention in an installed condition adjusted left and right.

FIG. 5 is a plane schematic view of the embodiment of the present invention in an installed condition adjusted diagonally.

### DETAILED DESCRIPTION OF THE PREFERRED EMBODIMENT

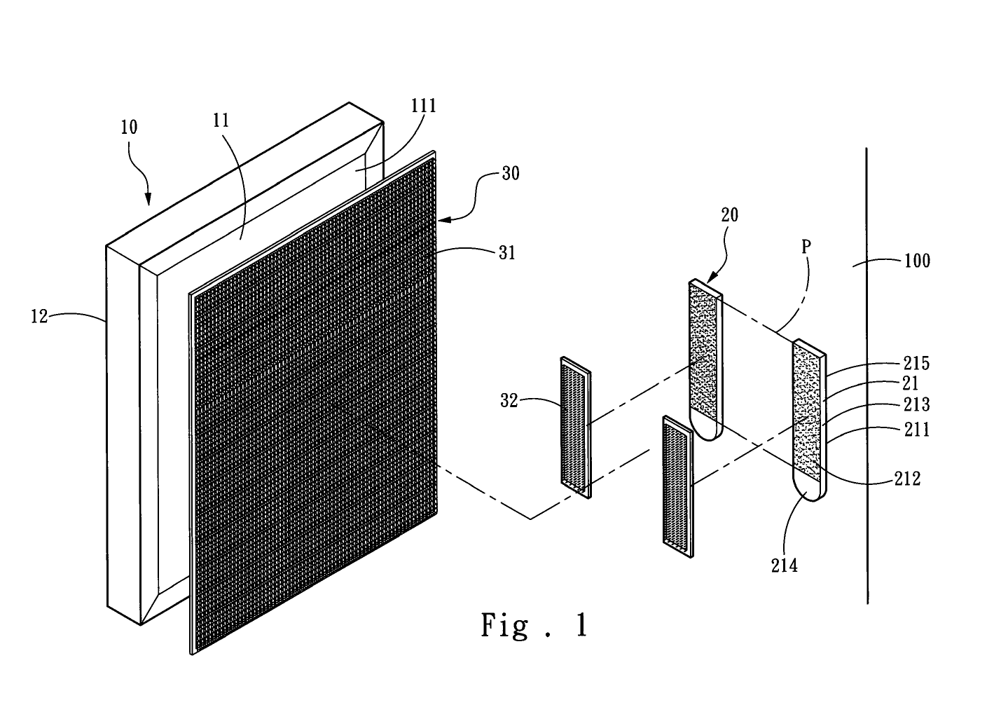

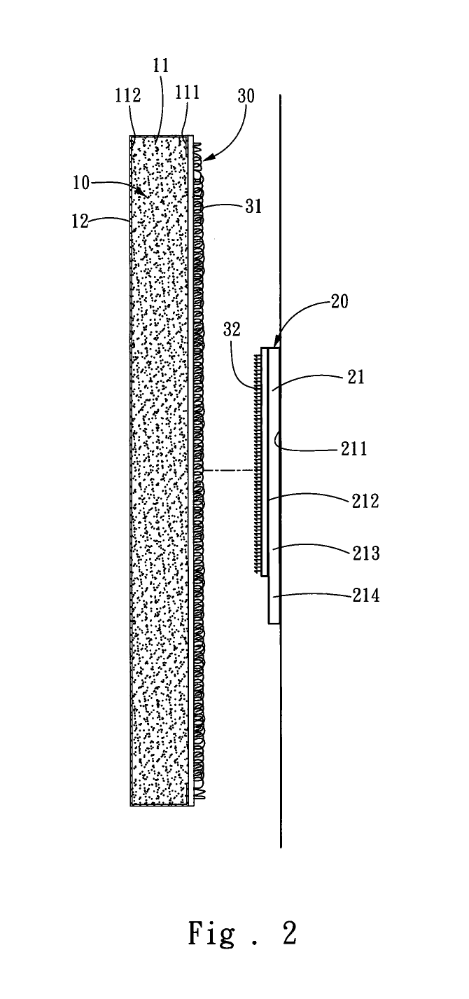

Please refer to FIGS. 1 and 2 for an embodiment of an ornament assembly with adjustable mounting locations of the present invention. It is desirable to be mounted onto a wall 100, and includes an ornament unit 10, a positioning adhesive strip unit 20 and an adhesion unit 30.

The ornament unit 10 has a baseboard 11 and a pattern layer 12 fixedly located on the baseboard 11. The baseboard 11 can be a light weight Styrofoam board, a cardboard, a corrugated cardboard or corrugated plastic board. The baseboard 11 includes a rear side 111 facing the wall 100 and a front side 112 opposite to the rear side 111. The pattern layer 12 is located on the front side 112. In this embodiment, the pattern layer 12, which would be paper (such as photo, painted article or the like) or fabric (such as patterned cloth), is bonded to the front side 112, or directly printed to cover the front side 112 (not shown in the drawings).

In this embodiment the positioning adhesive strip unit 20 includes two separate positioning adhesive strips 21 that are traceless adhesive strips to define a positioning zone P between the two positioning adhesive strips 21. Each of the positioning adhesive strips has respectively an inner adhesive surface 211 sticking on the wall 100, an outer adhesive surface 212 opposite to the inner adhesive surface 211, an elastic layer 213 interposed between the inner adhesive surface 211 and outer adhesive surface 212, a stretch portion 214 connected to the elastic layer 213 and a release paper 215 bonded to the inner adhesive surface 211. The two positioning adhesive strips 21 may also be substituted by only one positioning adhesive strip 21 having a greater size to achieve the same purpose.

In this embodiment the adhesion unit 30 includes a first adhesion member 31 prefixed to the rear surface 111 of the baseboard 11 and two elongate second adhesion members 32 adhering to the first adhesion member 31. The first adhesion member 31 can be a Velcro loop tape, while the second adhesion member 32 can be a Velcro hook tape pre-bonded to the outer adhesive surface 212. The first adhesion member 31 is formed at a size greater than the area including the positioning zone P and the second adhesion members 32.

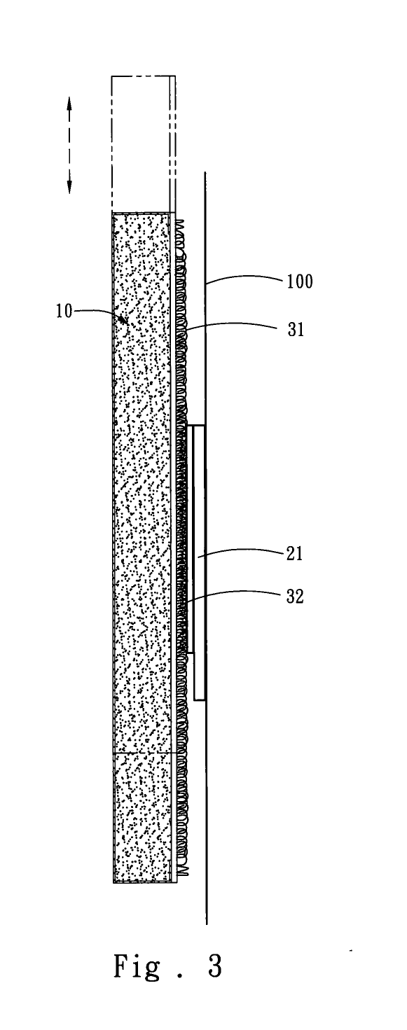

Referring to FIG. 2, before hanging the ornament unit 10, the release paper 215 peels from the inner adhesive surface 211, and the inner surface 211 of the positioning adhesive strips 21 is adhered to a desired mounting position of the wall 100. Since the second adhesion member 32 is pre-bonded to the outer adhesive surface 212, and the first adhesion member 31 is prefixed to the rear side 111 of the baseboard 11, the ornament unit 10 can aim at the positioning adhesive strip unit 20 and move toward the wall 100. Hence the first adhesion member 31 and second adhesion member 32 are adhered together to position the ornament unit 10 (referring to solid lines in FIG. 3).

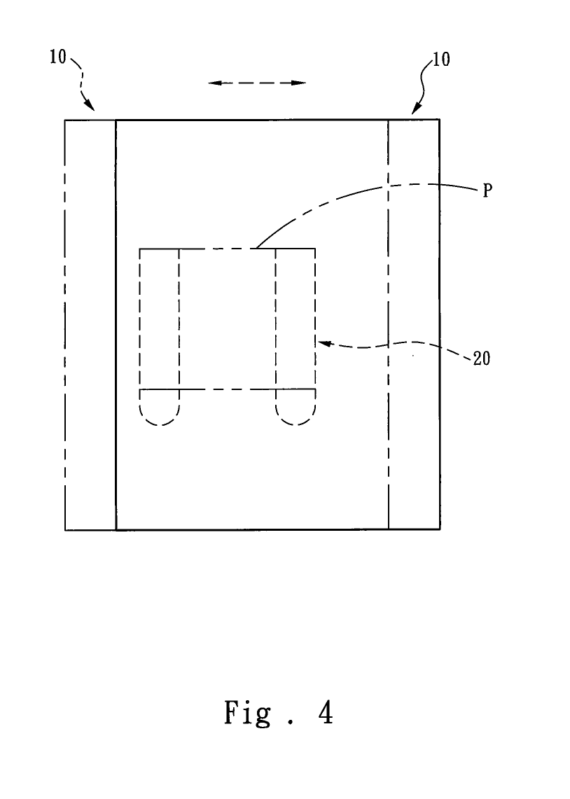

Also referring to FIG. 3 for the broken lines and FIG. 4, because the area of the first adhesion member 31 is greater than the positioning zone P and second adhesion members 32, the ornament unit 10 can be adjusted within a desired range. The adjustment can be accomplished by separating the ornament unit 10 and the first adhesion member 31 from the second adhesion members 32. After being adjust to a desired position, the ornament unit 10 can be move toward the wall 100 and form a fixing relationship with the wall 100.

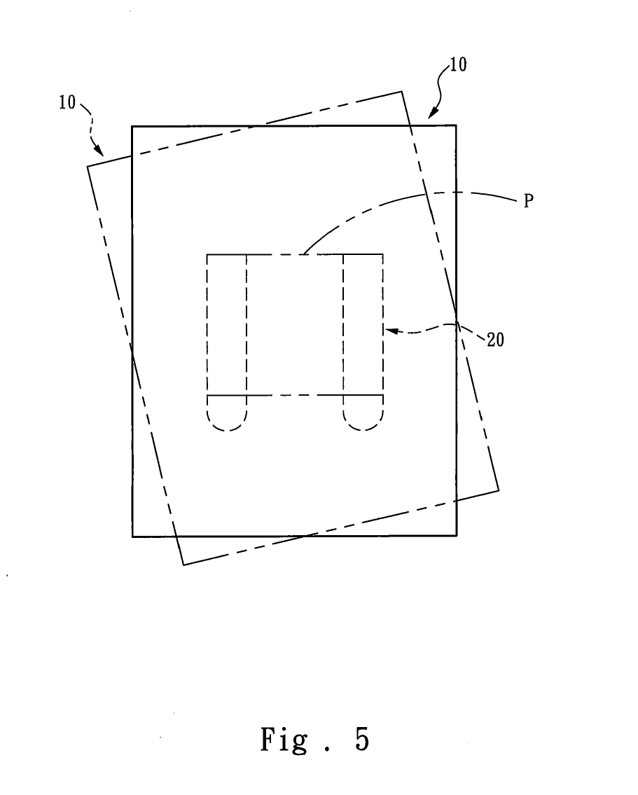

Referring to FIG. 5, through the first and second adhesion members 31 and 32, the ornament unit 10 can also be adjusted in a diagonal manner.

In the event that removing or changing hung location the ornament unit 10 is desired, the ornament unit 10 and first adhesion member 31 are removed from the second adhesion members 32. When the stretch portion 214 is pulled to stretch the elastic layer 213, the bonding force of the inner adhesive surface 211 against the wall 100 is diminished or vanished. Therefore, the positioning adhesive strip unit 20 can be cleared without damaging the wall 100. When mounting the ornament unit 10 again is desired, a new positioning adhesive strip unit 20 can be changed and attached on another desired location. It can be done easily.

It is to be noted that in this embodiment the second adhesion members 32 are formed in two elongate strips to mate the two positioning adhesive strips 21. Besides, in practice the second adhesion members 32 can be formed in a size same as the positioning zone P to cover the two positioning adhesive strips 21 to achieve the same purpose. Moreover, to facilitate marketing of the ornaments, the first adhesion member 31 may be only prefixed to the rear surface 111 of the ornament unit 10, and consumers can install the mating Velcro hook tape on the rear surface 111 to perform hanging.

In short, the present invention can achieve the following effects:

1. Through overall mating elements the ornament unit 10 can be hung securely, and adjusted up and down, and left and right after mounting.

2. Because the first adhesion member 31 is formed at a size greater than the positioning zone P defined by the positioning adhesive strips 21 and the second adhesion members 32, the positioning adhesive strip unit 20 can be fully covered by the ornament unit 10 without exposing, thus aesthetic appeal can be enhanced and hanging rope is no longer needed.

3. It is easier to adjust or remove the ornament unit 10.

4. The ornament unit 10 and positioning adhesive strip unit 20 can be separated and removed without leaving pits or traces on the wall 100.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An ornament assembly with adjustable mounting locations, comprising:
an ornament unit which includes a baseboard and a patterned layer, the baseboard containing a rear surface and a front surface opposite to the rear surface, the patterned layer being located on the front surface of the baseboard; and
an adhesion unit including a first adhesion member fastened to the rear surface of the baseboard.

2. The ornament assembly of claim 1 further including a positioning adhesive strip unit which includes an inner adhesive surface and an outer adhesive surface opposite to the inner adhesive surface, and a second adhesion member fastened to the outer adhesive surface and bondable to the first adhesion member.

3. The ornament assembly of claim 2, wherein the positioning adhesive strip unit defines a positioning zone, the first adhesion member being formed at a size greater than the positioning zone and the second adhesion member.

4. The ornament assembly of claim 3, wherein the baseboard of the ornament unit is selected from the group consisting of a Styrofoam board, a cardboard, a corrugated cardboard and a corrugated plastic board.

5. The ornament assembly of claim 4, wherein the positioning adhesive strip unit further includes an elastic layer interposed between the inner adhesive surface and the outer adhesive surface, a stretch portion connected to the elastic layer and a release paper bonded to the inner adhesive surface.

6. The ornament assembly of claim 5, wherein the first adhesion member is a Velcro loop tape and the second adhesion member is a Velcro hook tape.

7. The ornament assembly of claim 6, wherein the pattern layer is directly printed to cover the front surface of the baseboard.

8. The ornament assembly of claim 6, wherein the pattern layer is adhered to the front surface of the baseboard.

9. The ornament assembly of claim 1, wherein the baseboard of the ornament unit is selected from the group consisting of a Styrofoam board, a cardboard, a corrugated cardboard and a corrugated plastic board.

10. The ornament assembly of claim 2, wherein the positioning adhesive strip unit further includes an elastic layer interposed between the inner adhesive surface and the outer adhesive surface, a stretch portion connected to the elastic layer and a release paper bonded to the inner adhesive surface.

11. The ornament assembly of claim 2, wherein the first adhesion member is a Velcro loop tape and the second adhesion member is a Velcro hook tape.

12. The ornament assembly of claim 1, wherein the pattern layer is directly printed to cover the front surface of the baseboard.

13. The ornament assembly of claim 1, wherein the pattern layer is adhered to the front surface of the baseboard.
